(19) United States
(12) Patent Application Publication
(10) Pub. No.: US 2014/0235352 A1
(43) Pub. Date: Aug. 21, 2014

(54) SERVER DEVICE, AND NON-TRANSITORY COMPUTER-READABLE STORAGE MEDIUM

(71) Applicant: DeNA Co., Ltd., Tokyo (JP)

(72) Inventors: Ryuji IKEDA, Tokyo (JP); Kenichi IWAO, Tokyo (JP)

(73) Assignee: DeNA Co., Ltd., Tokyo (JP)

(21) Appl. No.: 14/163,930

(22) Filed: Jan. 24, 2014

(30) Foreign Application Priority Data
Feb. 19, 2013 (JP) 2013-030208

(51) Int. Cl. A63F 13/30

(52) U.S. Cl. CPC A63F 13/12
USPC 463/42

(57) ABSTRACT

A server device that controls a battle game, including: a player information storage unit configured to store game contents possessed by the player, battle game contents including game contents used when the player performs a battle against another player, and a battle parameter of the battle game contents; a sacrifice contents information storage unit configured to store sacrifice contents serving as a sacrifice when the player loses the battle, and an impact given by the sacrifice contents on the battle; a battle processing unit configured to perform the battle based on the battle parameter and the impact; and an information change unit configured to cause, as a result of the battle, sacrifice contents of a player who lost the battle to be not possessed by the player and possessed by a player who won the battle, and to change and store information in the player information storage unit.

### BACKGROUND OF THE INVENTION

1. Field of the Invention

The present invention relates to a server device and a game program.

2. Description of Related Art

Among games in which players (characters operated by the players) perform a battle against each other, a game in which the players bet items or the like on the battle, the items having been set before the battle, and a player who wins the battle can acquire the item is known (for example, JP 8-332282 A).

### SUMMARY OF THE INVENTION

For operators who provide such games on the network, it is desirable to have more players to participate in the battles so that the players can easily deepen exchanges. However, when the item some player bets on is not attractive for other players, or the items the players bet on have different rarity values or disproportionate values, the players' motivation for the battle may be impaired, and active battles may not be performed.

The present invention has been made in view of the foregoing, and an objective is to provide an interesting game that suppresses disproportion of items that the players bet on when performing a battle, without impairing the motivation of the players for the battle.

A principal invention of the present invention for solving the the-above problems is a server device configured to be connected with an information processing terminal through a network, and to control a game in which a player battles against another player from the information processing terminal through the network, which includes: a player information storage unit configured to store game contents possessed by the player, battle game contents including one piece or a plurality of game contents to be used when the player performs a battle against another player, and a battle parameter of the battle game contents; a sacrifice contents information storage unit configured to store sacrifice contents serving as a sacrifice when the player has lost the battle against the another player, and an impact given by the sacrifice contents on the battle; a battle processing unit configured to perform the battle of the player and the another player based on the battle parameter of the battle game contents and the impact; a transmission unit configured to transmit information related to a result of the battle to the information processing terminal of the player that has performed the battle; and an information change unit configured to cause, as a result of the battle, sacrifice contents of a player who has lost the battle to be not possessed by the player and to be possessed by a player who has won the battle, and to change and store information stored in the player information storage unit.

Other characteristics of the present invention will become clear from the description of the present specification and the appended drawings.

According to the present invention, an interesting game can be provided, which suppresses disproportion of items that the players bet on when performing a battle without impairing the motivation of the players for the battle.

### BRIEF DESCRIPTION OF THE DRAWINGS

FIG. 1 is a diagram illustrating an example of an overall configuration of a game system 1 according to the present embodiment;

FIG. 2 is a block diagram illustrating a functional configuration of a server device according to the present embodiment;

FIG. 3 is a block diagram illustrating a functional configuration of a player terminal according to the present embodiment;

FIG. 4 is a diagram illustrating an example of a data structure of card information stored in a data storage unit of the server device;

FIG. 5 is a diagram illustrating an example of a data structure of a card possessed by a player among the player information stored in the data storage unit of the server device;

FIG. 6 is a diagram illustrating an example of a data structure about a deck set by the player among the player information stored in the data storage unit of the server device;

FIG. 7 is a diagram illustrating an example of a data structure sacrifice contents information stored in the data storage unit of the server device;

FIG. 8 is a diagram describing a flow of a battle operation;

FIG. 9 is a diagram illustrating an example of a battle list screen;

FIG. 10 is a diagram illustrating an example of a battle list screen in which a part of the information is undisplayed;

FIG. 11 is a diagram illustrating an example of the battle list screen in which a part or all of the information related to sacrifice contents;

FIG. 12 is a flow diagram of various types of processing performed in battle processing;

FIG. 13 is a diagram illustrating an example of a battle result notification screen when the player wins a battle; and

FIG. 14 is a diagram illustrating an example of a data structure of the sacrifice contents information when a plurality of sacrifice contents is set.

### DETAILED DESCRIPTION OF THE INVENTION

At least the following matters will become clear according to the description of the present specification and the appended drawings.

A server device configured to be connected with an information processing terminal through a network, and to control a game in which a player battles against another player from the information processing terminal through the network, including: a player information storage unit configured to store game contents possessed by the player, battle game contents including one piece or a plurality of game contents to be used when the player performs a battle against another player, and a battle parameter of the battle game contents; a sacrifice contents information storage unit configured to store sacrifice contents serving as a sacrifice when the player has lost the battle against the another player, and an impact given by the sacrifice contents on the battle; a battle processing unit configured to perform the battle of the player and the another player based on the battle parameter of the battle game contents and the impact; a transmission unit configured to transmit information related to a result of the battle to the information processing terminal of the player that has performed the battle; and an information change unit configured to cause, as a result of the battle, sacrifice contents of a player who has lost the battle to be not possessed by the player and to be possessed by a player who has won the battle, and to change and store information stored in the player information storage unit.

According to such an information processing apparatus, in a game capable of capturing an enemy character, a user-friendly method of capturing an enemy character can be provided.

Further, in the server device, the player information storage unit may store the battle game contents based on a request from the information processing terminal of the player when the battle is performed, the sacrifice contents information storage unit may store the sacrifice contents based on a request from the information processing terminal of the player when the battle is performed, and the transmission unit may transmit, to the information processing terminal, all or a part of information of the battle game contents and the sacrifice contents stored when the battle is performed so that a part of the information is displayed on the information processing terminal of the player before the battle is started.

According to such a server device, a part of the information of the battle opponent can be undisplayed. Therefore, the player needs to determine the strength of the battle opponents while predicting the information of the undisplayed parts when selecting the battle opponent. This can provide a highly strategic battle game, and can enhance the interest of the player.

Further, in the server device, the impact may vary one of or both of the battle parameter of the battle game contents of the player and a battle parameter of battle game contents of the another player who battles against the player.

According to such a server device, the battle can become advantageous or disadvantageous for the player depending on the impact of the set sacrifice contents. Therefore, the battle game can become active.

Further, in the server device, the sacrifice contents information storage unit may store a plurality of the sacrifice contents based on a request from the information processing terminal of the player.

According to such a server device, a plurality of sacrifice contents can be set in advance. Therefore, even if having lost the battle and the sacrifice contents are taken, the player can save a time and effort to newly set the sacrifice contents.

Further, in the server device, the player information storage unit may store a point in a game possessed by the player, and the information change unit may decrease the point in a game possessed by the player when the player has lost the battle.

According to such a server device, when having lost the battle, the point in a game is decreased. Therefore, the players are encouraged to make an effort to win a battle, and the battle game can become active.

Further, in the server device, the battle processing unit may set restriction information that restricts performing of a battle next to the battle based on a predetermined condition after the player has performed the battle, and the player information storage unit may store the set restriction information.

According to such a server device, performing of continuous battles by the same player can be suppressed.

Further, in the server device, the battle processing unit may perform a comparison of at least one of the battle parameters of the battle game contents and the impacts of the player and the another player who battles against the player, and when a result of the comparison satisfies a predetermined condition, the battle processing unit may cause a battle result to be different from a normal battle result.

According to such a server device, a unilateral battle in which a difference in ability between the players is large is less likely to be generated, and a sense of unfairness provided to the players can be suppressed.

Further, a game program for causing a server device to realize a game in which a player battles against another player from an information processing terminal through a network has become clear, the program for causing the server device to realize: a function to store game contents possessed by the player, battle game contents including one piece or a plurality of game contents to be used when the player performs a battle against another player, and a battle parameter of the battle game contents in a player information storage unit; a function to store sacrifice contents serving as a sacrifice when the player has lost the battle against the another player, and an impact given by the sacrifice contents on the battle in a sacrifice contents information storage unit; a function to perform the battle of the player and the another player based on the battle parameter of the battle game contents and the impact, by a battle processing unit; a function to transmit information related to a result of the battle to the information processing terminal of the player that has performed the battle, by a transmission unit; and a function to cause as a result of the battle, sacrifice contents of a player who has lost the battle to be not possessed by the player and to be possessed by a player who has won the battle, and to change and store information stored in the player information storage unit, by an information change unit.

### Embodiments

<<Configuration of Game System 1>>

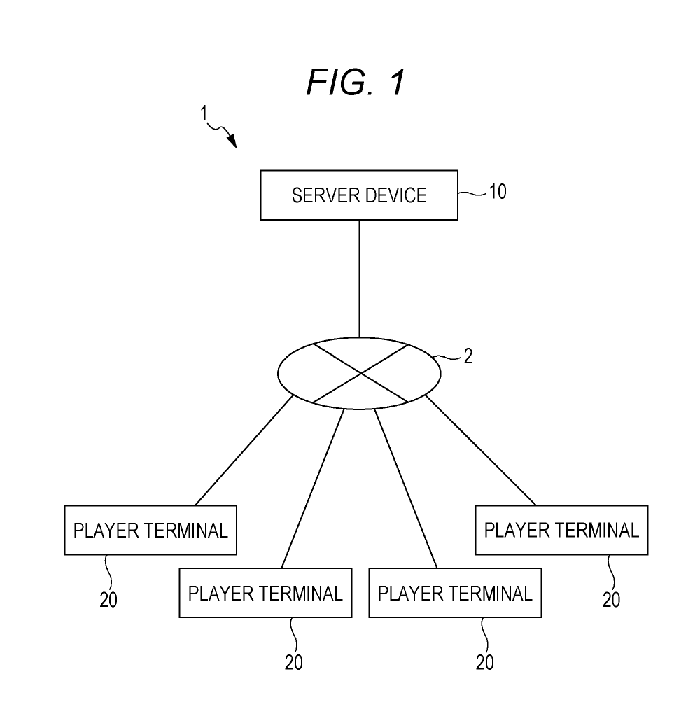

FIG. 1 is a diagram illustrating an example of an overall configuration of a game system 1 according to the present embodiment.

The game system 1 provides network 2 related to a game (a social game, and the like) to a user (hereinafter, may be referred to as “player”). The game system 1 includes the server device 10 and a plurality of player terminal 20 connected to a network 2 in a communication capable manner.

The player can play a game transmitted through the network 2 by accessing the game system 1 from the player terminal 20. Further, the player can communicate with a plurality of other players by accessing the game system 1.

The game system 1 of the present embodiment provides a game in which the player can perform a battle against other players.

<Server Device 10>

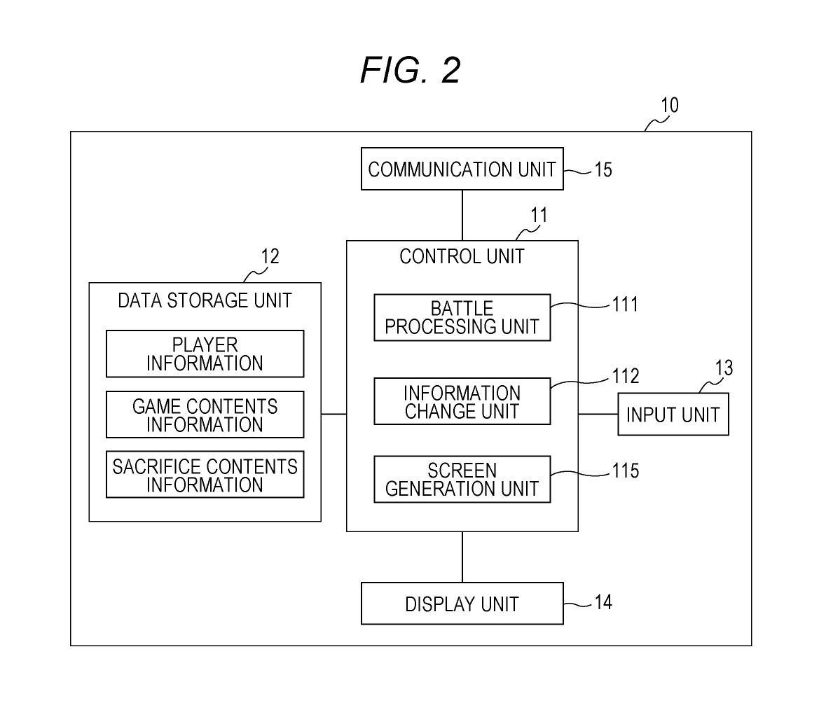

FIG. 2 is a block diagram illustrating a functional configuration of a server device. The server device 10 is an information processing device (for example, a workstation, a personal computer, and the like) used when a system administrator and the like manage the game service. The server device 10 can distribute a game program operable on the player terminal 20, and a web page and the like made in a markup language (HTML, and the like) according to a specification of the player terminal 20 upon receiving various commands (requests) from the player terminal 20. The server device 10 of the present embodiment includes a control unit 11, a data storage unit 12, an input unit 13, a display unit 14, and a communication unit 15.

The control unit 11 performs delivery of data among units and controls the whole server device 10. The control unit 11 includes a battle processing unit 111, an information change unit 112, and a screen generation unit 115. A detailed operation of each unit will be described below.

The data storage unit 12 includes a read only memory (ROM) that is a read only storage area in which a system program is stored, and a random access memory (RAM) that is a rewritable storage area used as a work area for arithmetic processing by the control unit 11. The data storage unit 12 is, for example, realized by a non-volatile storage device, such as a flash memory or a hard disk. The data storage unit 12 of the present embodiment stores information related to game contents (for example, game cards) and items used in a game. Further, the data storage unit 12 stores game contents possessed by the player in a game, player information that is information related to battle game contents configured from the game contents possessed by the player in a game, information related to sacrifice contents used in a battle, and the like. That is, the data storage unit 12 is a player information storage unit and a sacrifice contents information storage unit. A data structure of each piece of information will be described below.

The input unit 13 is used by a system administrator and the like for inputting various types of data and setting related to a game (for example, setting of sacrifice contents described below and the like), and is, for example, realized by a keyboard, a mouse, and the like.

The display unit 14 is used for displaying an operation screen for the system administrator based on a command from the control unit 11, and is, for example, realized by a liquid crystal display (LCD) and the like.

The communication unit 15 is used for performing communication with the player terminal 20, and has a function as a reception unit that receives various data and signals transmitted from the player terminal 20, and a function as a transmission unit that transmits various data and signals to the player terminal 20 according to a command of the control unit 11. The communication unit 15 is, for example, realized by a network interface card (NIC), and the like.

<Player Terminal 20>

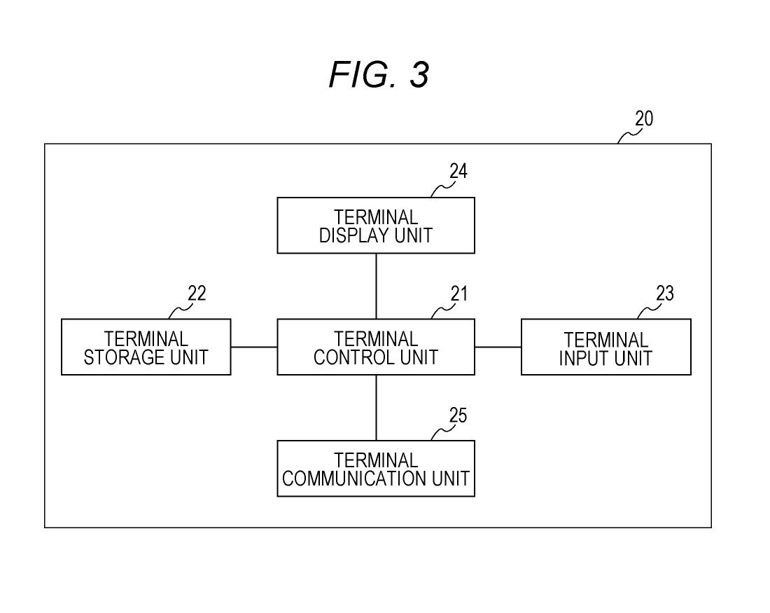

FIG. 3 is a block diagram illustrating a functional configuration of the player terminal 20. The player terminal 20 is an information processing terminal operated by the player (the user) when the user plays a game. The player terminal 20 is, for example, a mobile phone terminal, a smart phone, a personal computer, a game device, or the like, and transmits/receives information to/from the server device 10 accessible through the network 2. The player terminal 20 of the present embodiment includes a terminal control unit 21, a terminal storage unit 22, a terminal input unit 23, a terminal display unit 24, and a terminal communication unit 25.

The terminal control unit 21 performs data passing among units and controls the entire player terminal 20, and is realized by the central processing unit (CPU) executing a program stored in a predetermined memory. Note that the terminal control unit 21 of the present embodiment also functions as a screen display control unit that controls a display form of the game screen displayed in the terminal display unit 24.

The terminal storage unit 22 is connected to the terminal control unit 21 through a bus, and performs processing of referring to, reading out, rewriting stored data according to a command from the terminal control unit 21. The terminal storage unit 22 is realized, for example, by a flash memory, a hard disk, and the like.

The terminal input unit 23 is used for performing various operations (a game operation a text input operation, and the like) by the player, and is realized, for example, by an operation button, a touch panel, and the like.

The terminal display unit 24 is used for displaying a game screen (for example, a battle selection screen terminal and the like) generated based on game information by a command from the control unit 21, and is, for example, realized by a liquid crystal display (LCD), and the like.

The terminal communication unit 25 is used for performing communication with the server device 10, and includes a function as a reception unit that receives various types of data and signals from the server device 10, and a function as a transmission unit that transmits various types of data and signals to the server device 10 according to a command of the terminal control unit 21. The terminal communication unit 25 is, for example, realized by a network interface card (NIC), and the like.

### Outline of Game

An outline of a game provided by the game system 1 will be described.

The game system 1 of the present embodiment can provide the player (the user) with a battle game performed using game contents. Hereinafter, a battle-type card game performed using a game card as an example of game contents will be described. Note that the game card is a card game as digital contents, and therefore, the card game is a virtual card used in a virtual space on the game.

<Battle-Type Card Game>

The game system 1 according to the present embodiment can provide a battle-type card game that determines an outcome by causing a character selected by the player with a character of a battle opponent player.

In the battle-type card game, first, the player selects a character for performing a battle. In the present embodiment, the player can possess a plurality of game cards (virtual cards used in the virtual space of the game), and each of the game cards corresponds to a game character. Therefore, when one or a plurality of game cards to be used for a battle is selected from among the plurality of game cards possessed by the player, a character corresponding to the selected game card is set as a character (battle game contents) for performing the battle.

Here, among the battle game contents, attack-type battle game contents used when attacking an opponent at a battle and defense-type battle game contents used when defending the player character from the opponent are set.

To be specific, the player selects ten game cards (ten characters) from among the game cards possessed by the player to compose the attack-type battle game contents, as the battle game contents to be used at attacking. Hereinafter, the attack-type battle game contents are also referred to as “attack deck”. The strength of the attack deck is comprehensively determined based on a parameter (for example, an attack strength) set to each of the selected ten game cards. For example, a total value of the attack strength set to each of the ten game cards is stored in the data storage unit 12 as a battle parameter of the attack deck. An actual attack strength of the player at a battle is determined based on the battle parameter of the attack deck. Similarly, the player selects ten game cards (ten characters) from among the game cards possessed by the player to constitute defense-type battle game contents, as the battle game contents to be used at defending. Hereinafter, the defense-type battle game contents are also referred to as “defense deck”. The strength of the defense deck is comprehensively determined based on a parameter (for example, a defense strength) set to each of the selected ten game cards, and is stored in the data storage unit 12 as a battle parameter of the defense deck. An actual defense strength of the player at a battle is determined based on the battle parameter of the defense deck. Note that the method of determining the number of game cards that constitute a deck or the strength of a deck is not limited to the above-described method.

Note that a level is set to each game card (a character corresponding to the game card), and a value of a parameter (for example, an attack strength or a defense strength) set to the game card is increased according to an increase in level. Therefore, when a deck is composed using a game card having a high level, stronger battle game contents can be built. Therefore, the battle against another player can be advantageously developed.

After the attack deck and the defense deck are composed, the player selects a battle opponent player and launch a battle to start the battle. When the battle is started, the control unit 11 compares the attack strength based on the attack deck composed by the player and the defense strength based on the defense deck of the player selected as the battle opponent. When the attack strength of the player is larger than the defense strength of the opponent player, the control unit 11 determines a victory of the player, and when the attack strength of the player is the defense strength or less of the opponent player, the control unit 11 determines a defeat of the player. On the other hand, when the player is selected by another player as a battle opponent (that is, a battle is launched), the outcome of the battle is determined by comparison of the defense strength of the player and the attack strength of the another player.

Note that the method of determining an outcome at a battle is not limited to the above described method, and a method of determining a side that provides an opponent with a larger damage to be a winner, a method of determining a side that causes a hit point of the opponent to be zero first to be a winner, or the like may be employed.

The player who has won a battle can acquire currency in a game that can be used in a game as a victory reward, a point in a game such as an experience value, an item to be used in a game, and the like. Further, the acquired experience value is added to the game card used in the battle, and the experience value reaches a certain value or more, the level of the game card is increase. Further, the player can acquire “sacrifice contents” the battle opponent has bet on.

<Sacrifice Contents>

In the game system 1, the “sacrifice contents” is set to each of the above-described attack deck and defense deck. In the present embodiment, the sacrifice contents are game cards among the plurality of game cards possessed by the player separately set from the attack deck and the defense deck. The sacrifice contents have a function to have some impact on the battle of the players. In the present embodiment, the sacrifice contents have a function to vary the battle parameter (attack strength) of the attack deck or the battle parameter (defense strength) of the defense deck of the player or both of the parameters. For example, when a game card Z is set to the attack deck as the sacrifice contents, for example, a 10% value of the parameter (attack strength) at a maximum level of the game card Z is added to the attack strength of the attack deck. In this case, as the parameter of the game card set as the sacrifice contents are stronger, the attack strength of the attack deck can be strongly varied. As other impacts due to setting of the sacrifice contents, the battle may be advantageously developed by varying the defense strength of the defense deck of the battle opponent to be lower, or causing a special effect (for example, exercising a special technique) on the own attack deck.

Note that the battle can be performed without setting the sacrifice contents to the battle game contents (deck). Note that, when the sacrifice contents are not set, an advantageous impact (effect) as described above cannot be obtained. Therefore, there is a higher possibility of being disadvantageous in a battle against another player who sets the sacrifice contents.

Further, the sacrifice contents have a function as a wager the players bet on in a battle of the players. In the game system 1, when a battle is performed against another player using the attack deck (defense deck) to which the sacrifice contents are set and the player is defeated, the sacrifice contents set to the deck is taken by the battle opponent player. On the other hand, when the player wins the battle, the player can take the sacrifice contents set to the deck of the battle opponent player. That is, the sacrifice contents are treated as a type of reward at a victory of a battle.

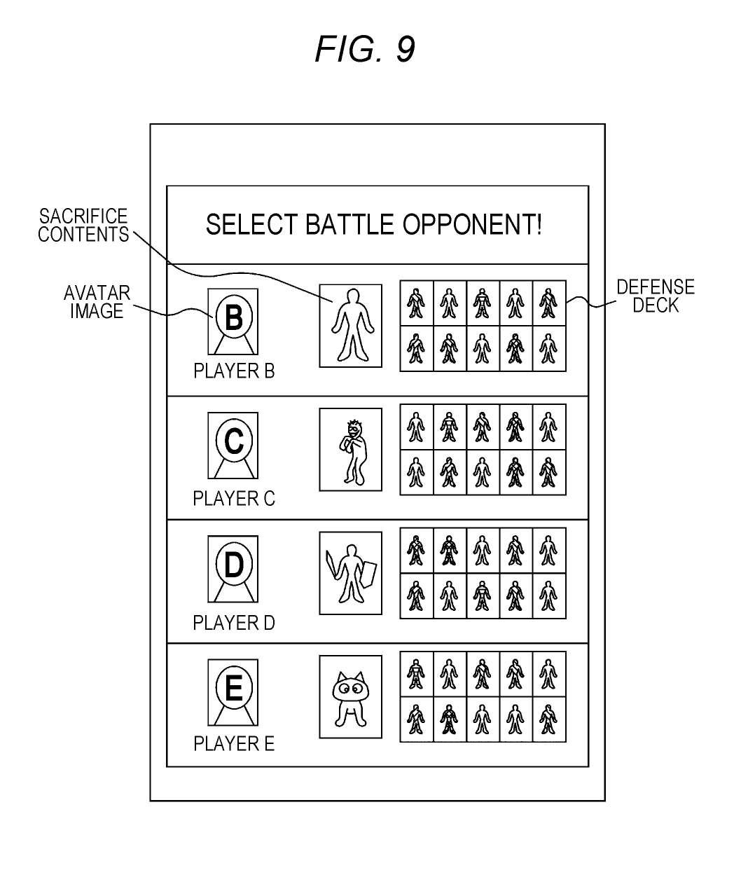

Note that, while details will be described below, when the player selects a battle opponent player, the player performs the selection of a battle opponent while viewing a screen on which a part of the defense decks of battle opponent candidates and the sacrifice contents set to the defense decks (see FIG. 9). Therefore, the player can select a reward to be obtained when winning the battle by him/herself, and the problems of disproportion of the sacrifice contents and the like bet at a battle is less likely to be caused.

### Data Structure

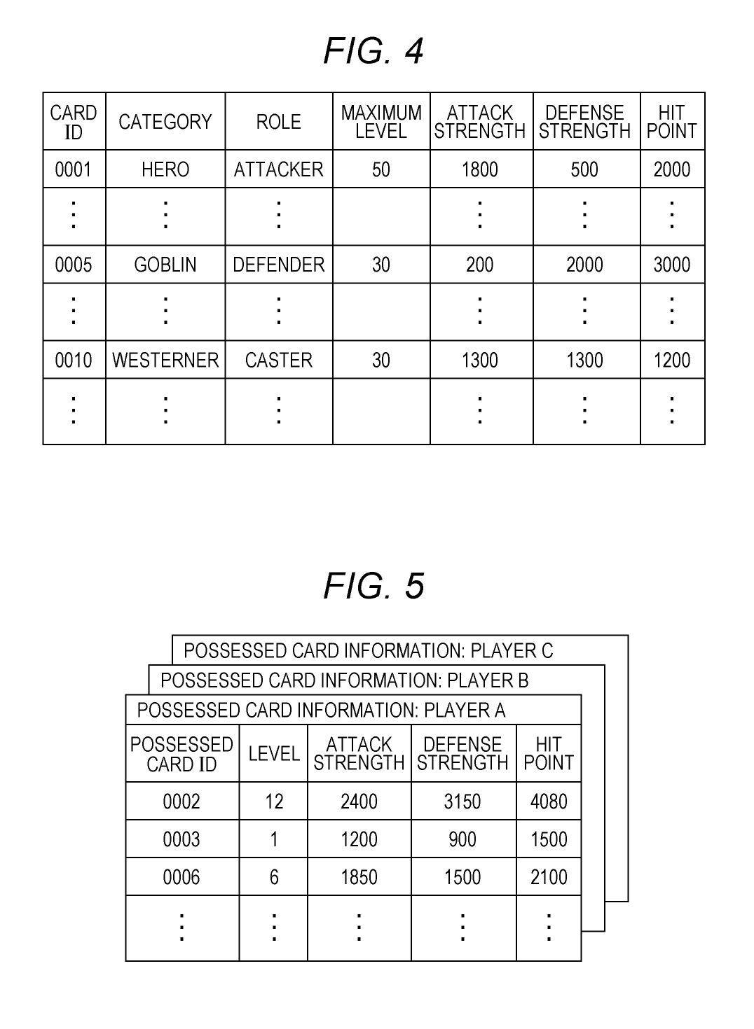

As described above, the data storage unit 12 of the server device 10 stores various types of information such as information related to the game cards and the items as the game contents, the player information, and the sacrifice contents information. The various types of information used in the game system 1 of the present embodiment will be described with reference to FIGS. 4 to 7.

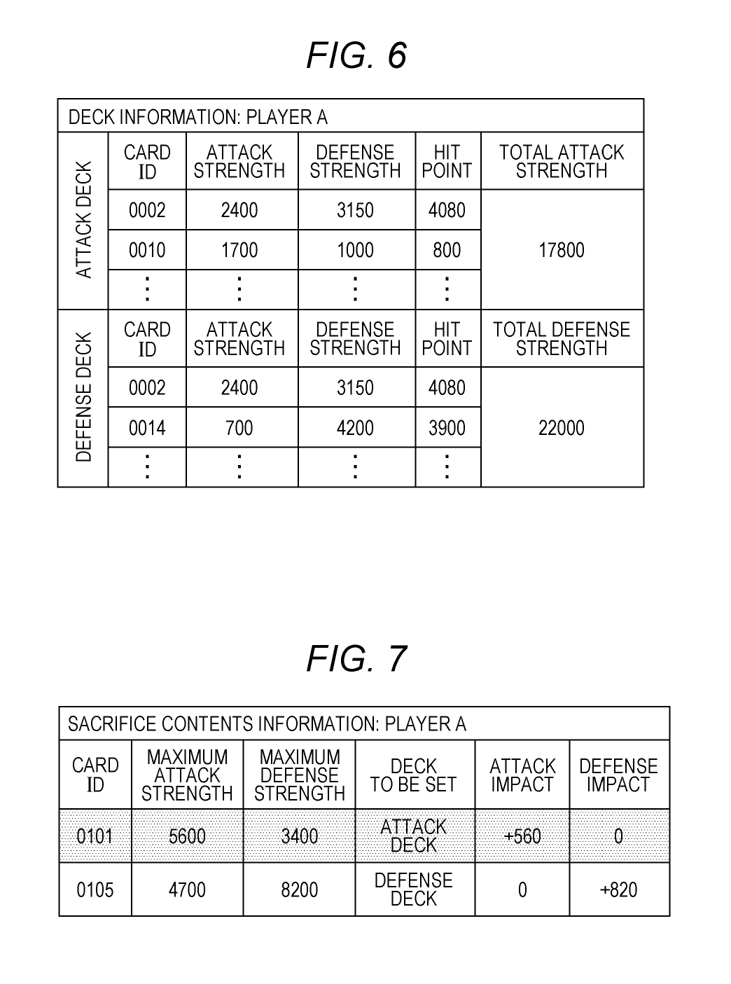

FIG. 7 is a diagram illustrating an example of a data structure of the card information. FIG. 5 is a diagram illustrating an example of a data structure of a card possessed by the player among the layer information. FIG. 6 is a diagram illustrating an example of a data structure of a deck set by the player among the player information. FIG. 7 is a diagram illustrating an example of a data structure of the sacrifice contents information.

<Card Information>

The card information is configured from a card ID as an example of identification information that identifies a game card and various types of information related to the game card associated with the card ID. For example, as illustrated in FIG. 4, the card information includes a card ID, a category of a character associated with the game card, a role, a maximum level of the character, and various parameters such as the attack strength, the defense strength, and the hit point at an initial level. Other than the above, information such as rarity (rarity value) of the game card and a skill (special ability) may be provided.

<Player Information>

Possessed card information in the player information is information indicating a game card possessed by each player (hereinafter, may be referred to as possessed card). Note that each game card has a unique parameter, and the parameter is stored in the data storage unit 12 in association with the ID of each game card. For example, as illustrated in FIG. 5, the possessed card ID, the level of the character corresponding to the game card, and the various parameters such as the attack strength, the defense strength, and the hit point are included. The various parameters such as the attack strength can be calculated from an initial parameter (see FIG. 4) of a game card recorded as the card information and the level of the game card at a present time. Further, information such as a date and time at which the player acquired the possessed card may be included other than the above information.

Deck information in the player information is information related to the attack deck and the defense deck composed by each player. Note that, in the game system 1, a “normal deck” used at a timing other than a battle (for example, an event in a game, or the like) is composed. A data structure of the normal deck is similar to that of the attack deck or the defense deck. Therefore, description is omitted. The deck information illustrated in FIG. 6 includes a plurality of possessed card IDs (for example, ten IDs) that constitute each of the attack deck and the defense deck, the parameters of the attack strength, the defense strength, and the like according to the level of each possessed card, and a battle parameter that is a parameter of all of the decks used at a battle (for example, the attack strength as all of the attack decks), and the like.

Note that, an ID of the player, an experience value, information related to an item and currency in a game possessed by the player are stored as the player information other than the possessed card information and the deck information.

<Sacrifice Contents Information>

The sacrifice contents information includes an ID of a possessed card set as sacrifice contents, various parameters such as a maximum attack strength of the card, a deck to be set, and data related to an impact on a battle. For example, in FIG. 7, among the possessed card of the player, a game card having a card ID 0101 is set as the sacrifice contents of the attack deck. In this case, as an impact on the attack deck at a battle, a 10% value of the maximum attack strength of the game card (+560) is set to be added to the attack strength of the attack deck. Similarly, among the possessed card of the player, a game card having an card ID 0105 is set as the sacrifice contents of the defense deck. As an impact on the defense deck at a battle, a 10% value of the maximum defense strength of the game card (+820) is set to be added to the defense strength of the defense deck. Note that, as an impact that some sacrifice contents of the attack deck provide the attack deck at a battle, a 15% value of the total attack strength may be set to be added to the attack strength of the attack deck. Similarly, as an impact that some sacrifice contents of the defense deck provides the defense deck, a 15% value of the total defense strength may be set to be added to the defense strength of the defense deck. Other than the above, a parameter set to the sacrifice contents itself may be added to the battle parameter, and the sacrifice contents may be treated as an extra card. This enables a player who sets stronger sacrifice contents (having higher rarity) to advantageously develop a battle than a player who does not set the sacrifice contents or a player who set weaker sacrifice contents (having lower rarity)

### Operation of Battle

Next, a battle operation performed in the game system 1 will be described in detail.

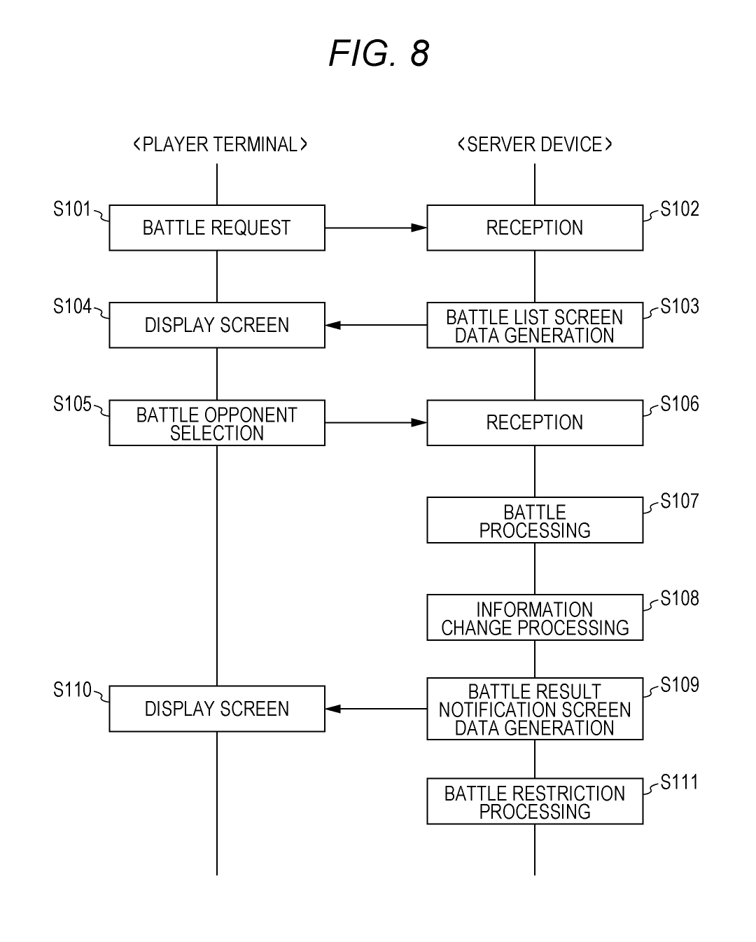

FIG. 8 is a diagram describing a flow of a battle operation of the present embodiment. Assume that the composition of the attack deck and the defense deck to be used in a battle has already been completed. Further, description will be given on the assumption that the outcome of the battle is performed based on the attack strength of the attack-side player and the defense strength of the defense-side player.

First, a player who wishes a battle against another player (player A) requests a battle through the player terminal 20 (S101). The request of a battle is performed on a game screen (not illustrated) displayed on the terminal display unit 24 of the player terminal 20, and is transmitted to the server device 10 through the terminal communication unit 25.

When the server device 10 has received the battle request from the player A (S102), a data of a battle list screen for prompting the player A to select a battle opponent is generated (S103). The control unit 11 extracts a plurality of other players from among the users of the game system 1 as candidates of the battle opponents of the player A. Then, the screen generation unit 115 generates data of a battle list screen including the extracted battle candidate players, the defense decks of the battle candidate players, and information of the sacrifice contents set to the defense decks. FIG. 9 is a diagram illustrating an example of the battle list screen. On the battle list screen illustrated in FIG. 9, information related to four players of players B to E is displayed as the battle candidate players. For example, images of avatars of the players, the defense decks composed by the respective players, and the sacrifice contents set to the defense decks are displayed. Further, information indicating levels, or strengths of the sacrifice contents or of each character that constitutes the defense decks, or the like (not illustrated) may be displayed.

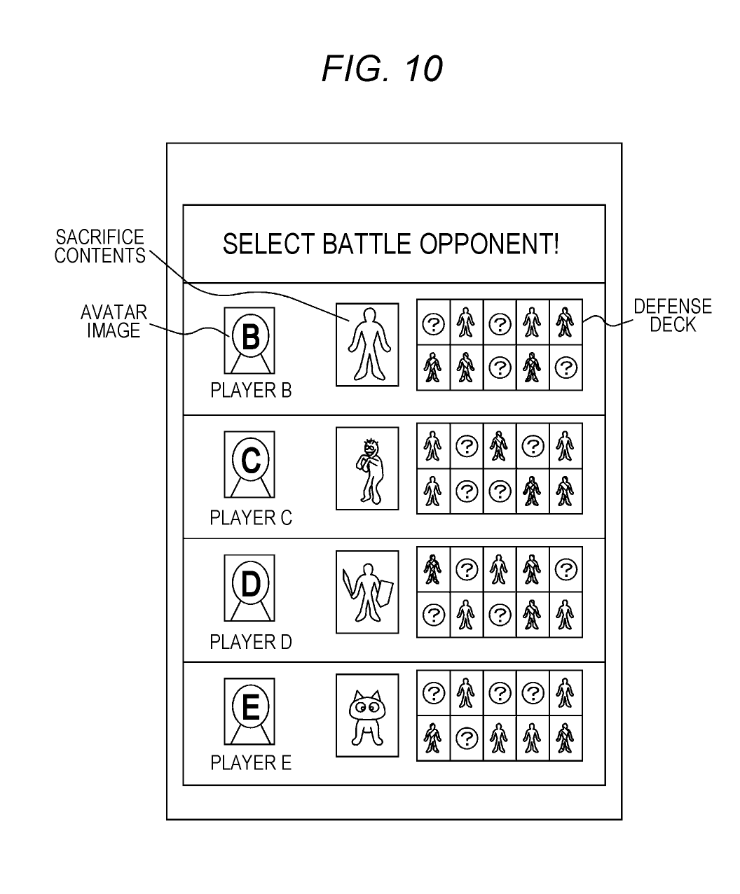

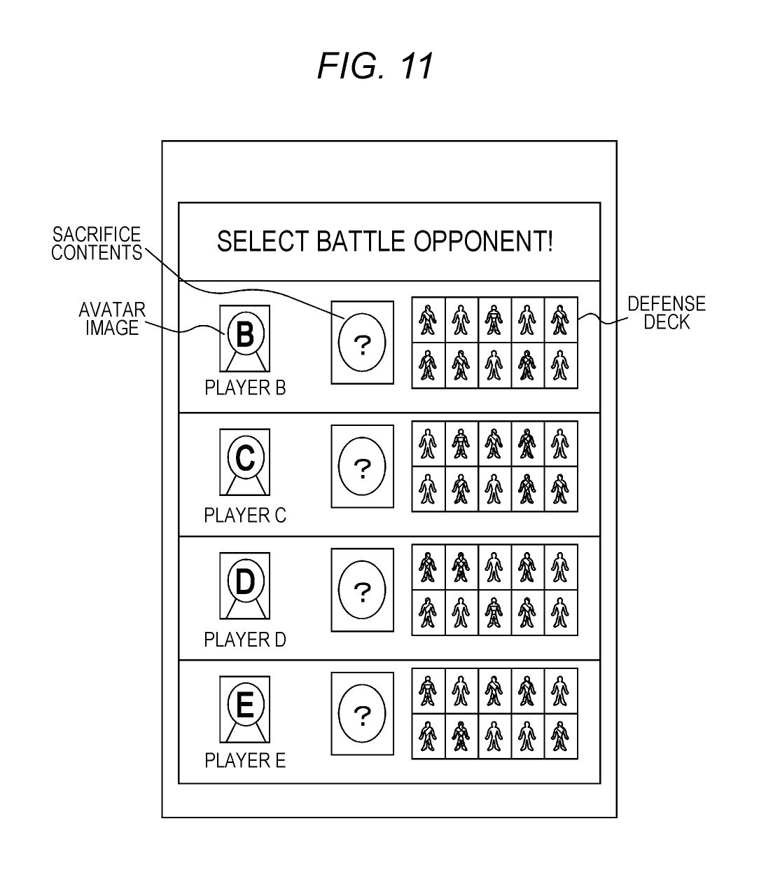

Note that all of the information may not be displayed, and a part of the information may be undisplayed. FIGS. 10 and 11 are diagrams illustrating examples of the battle list screen in which a part of the information is undisplayed. In FIG. 10, a part (or all) of the information of the characters (game cards) composed in the defense decks of the battle candidate players is undisplayed. In FIG. 11, a part or all of the information related to the sacrifice contents are undisplayed. Note that information other than the above may be undisplayed. Since a part of the information of the battle opponent is undisplayed, the player A needs to determine the strength of the battle opponents while predicting the information of the undisplayed parts when selecting the battle opponent. Especially, when a part of the information related to the sacrifice contents like FIG. 11, the player A tries to set stronger sacrifice contents. This enhances an interest of the player A at a battle, and distribution of strong sacrifice contents becomes active.

When the battle list screen is generated, an arbitrary player is selected as a battle opponent candidate. However, to suppress an unfair battle described below, a player who composed the defense deck having a similar strength may be preferably extracted by reference to the strength of the attack deck of the player A. When a battle occurs between players having a similar strength, the battle is more likely to be a close battle, and more thrilling development can be expected by the players.

The generated data of the battle list screen is transmitted to the player terminal 20 of the player A by the communication unit 15, and a battle list screen like ones illustrated in FIGS. 9 to 11 is displayed in the terminal display unit 24 (S104). Note that, when a part of the information of the battle list screen is undisplayed like FIG. 10 or 11, all of the data (information) are not necessarily transmitted to the player terminal 20, and a part of the data may be transmitted.

The player A selects a player who wishes a battle while viewing the displayed battle list screen (S105). In the cases of FIGS. 9 to 11, any player from among the players B to E displayed on the battle list screen is selected. As described above, in the game system 1, it is important to consider the sacrifice contents set by the battle candidate players well in selecting a battle opponent. This is because the sacrifice contents have a function to have an impact on the battle such as to reinforce the deck and the like, at the same time as to serve as the victory reward of the battle. For example, when strong sacrifice contents having a high rarity value is set to the defense deck of the battle candidate player, on the one hand the game card having the high rarity value can be acquired when wins a battle, a possibility of losing the battle becomes higher on the other hand. Also, it may be a tactics to set weaker sacrifice contents so as to put the player off his/her guard. Further, by causing a part of the battle candidate players to be undisplayed like FIGS. 10 and 11, the player needs to assume various statuses. Therefore, a highly strategic battle game can be provided.

When the player A selects a player to become a battle opponent, and the selection of the player is received by the server device 10 (S106), a battle is started. Hereinafter, description will be given on the assumption that the player B is selected as a battle opponent of the player A.

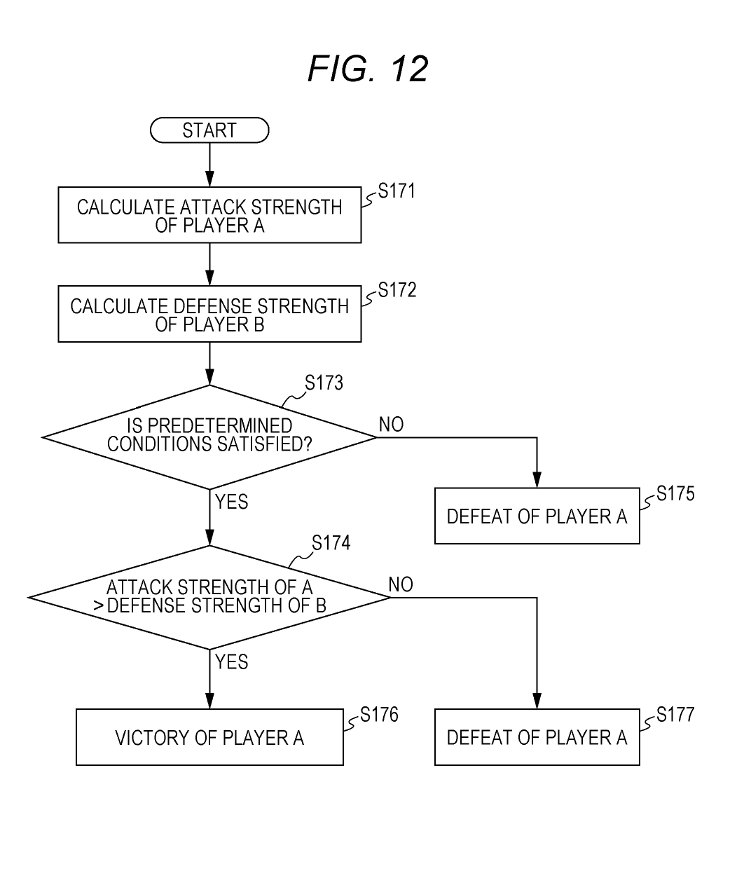

When a battle is started, the battle processing unit 111 of the control unit 11 performs battle processing (S107). FIG. 12 is a flow diagram, of various types of processing performed in the battle processing.

When the battle is started, the battle processing unit 111 calculates the attack strength of the player A who has requested the battle (S171). To be specific, the battle processing unit 111 refers to attack strength data of the attack deck in the player information of the player A stored in the data storage unit 12, and refers to data related to an impact of the sacrifice contents set to the attack deck in the sacrifice contents information of the player A. The battle processing unit 111 defines a value obtained by adding the impact of the sacrifice contents to the attack strength of the attack deck as a modified attack strength of the player A. That is, a value obtained by varying the attack strength (battle parameter) of the attack deck by the impact of the sacrifice contents is the modified attack strength. Note that, as described above, impacts of the sacrifice contents on the battle vary. Therefore, the way of varying of the attack strength is different depending on the type of the sacrifice contents.

Following that, the battle processing unit 111 calculates the defense strength of the player B selected as the battle opponent (S172). To be specific, the battle processing unit 111 refers to defense strength data of the defense deck in the player information of the player B stored in the data storage unit 12, and refers to data related to the impact of the sacrifice contents set to the defense deck in the sacrifice contents information of the player B. Then, the battle processing unit 111 defines a value obtained by adding the impact of the sacrifice contents to the defense strength of the defense deck as a modified defense strength of the player B in the battle.

Next, the battle processing unit 111 determines whether the attack strength of the player A and the defense strength of the player B fall within a predetermined condition (S173). Here, the predetermined condition means a difference in ability between the players to perform the battle is not too large, and the like.

In the game system 1 of the present embodiment, the attack-side player can select the battle opponent (defense-side player), but the defense-side player cannot select the battle opponent (attack-side player). Therefore, when an attack-side player selects a defense-side player who is much weak than the attack-side player as the battle opponent, and launches a battle, the attack-side player can almost certainly win the battle. Therefore, the attack-side player can unilaterally take the sacrifice contents of the battle opponent. In such a case, since the defense-side player has no means to cope with such situation by him/herself, he/she feels more unfairness and may lose the interest in the game.

Therefore, in a battle, a predetermined condition is provided, and a battle of the players having too large ability difference is avoided. For example, as the predetermined condition, “the modified attack strength of the player A is not larger than a predetermined value or more with respect to the modified defense strength of the player B” is set. Then, when the modified attack strength of the player A falls outside the predetermined condition (No in S173), it is considered that an unfair battle has been performed, and the attack-side player A is determined to be defeated (S175). Alternatively, the battle may be determined to be a draw or the battle itself may be determined to a failure. Usually, as a result of a comparison between the modified attack strength of the player A and the modified defense strength of the player B, if the modified attack strength of the player A is higher than the modified defense strength of the player B, a victory of the player A is determined. However, when an unfair battle is performed, at least the victory of the player A is not determined In other words, a battle result different from a usual battle is determined.

Note that, as the predetermined condition, the attack strength (the battle parameter before being varied due to the impact of the sacrifice contents) of the attack deck of the player A and the defense strength (the battle parameter before being varied due to the impact of the sacrifice contents) of the defense deck of the player B may be compared, or the impact of the sacrifice contents on the battle itself may be compared. Alternatively, a difference between the levels both side to perform the battle may be compared.

Further, to suppress occurrence of an unfair battle in advance, after receiving selection of a battle opponent from the player A (S106), the server device 10 may cause the player terminal 20 of the player A to display a warning that informs an unfair battle may occur.

When the predetermined condition has been satisfied in S173 (Yes in S173), the modified attack strength of the player A and the modified defense strength of the player B are compared (S174). Note that a coefficient based on a random number may be added to the modified attack strength of the player A and the modified defense strength of the player B. Then, as a result of the comparison, when the modified attack strength of the player A is higher than the modified defense strength of the player B, the victory of the player A is determined (S176), and the modified attack strength of the player A is the modified defense strength of the player B or less, the defeat of the player A is determined (S177).

Referring back to FIG. 8, after the determination of an outcome of the battle processing is performed, information change processing is performed based on the determination (S108). In the information change processing, the information change unit 112 of the control unit 11 changes possession information of a game card or an item possessed by the player, a point in a game, and the like. Especially, it is a characteristic of the game system 1 that the possession of the sacrifice contents is transferred according to an outcome of the battle. Hereinafter, an example of when the player A wins a battle that is performed between the players A and B will be described.

The information change unit 112 accesses the possessed card information of the player B who has lost the battle (see FIG. 5), and changes the possession information of the game card corresponding to the sacrifice contents set to the defense deck into being unpossessed and stores the information. In addition, the information change unit 112 accesses the sacrifice contents information of the player B (see FIG. 7), and cancels the setting of the sacrifice contents set to the defense deck. Meanwhile, the possession information of the game card corresponding to the sacrifice contents is added to the possessed card information of the player A who has won the battle. This enables the sacrifice contents of the player B who has been defeated becomes unpossessed by the player B, and becomes possessed by the player A. In other words, the owner of the sacrifice contents is transferred from the loser to the winner.

When such information change processing is performed, the defense deck of the player B becomes in a state in which no sacrifice contents are set to the defense deck, and this brings disadvantages for subsequent battles against other players. Therefore, a player having the defense deck in which no sacrifice contents are set may be less likely to be selected as the battle candidate player. Further, as described below, a plurality of sacrifice contents may be set in advance.

Note that, when the player A is defeated by the player B in a battle, the possession of the sacrifice contents set to the attack deck of the player A is transferred to the Player B.

Further, in the information change processing, the currency in a game and an experience value (hereinafter, collectively referred to as point in a game) possessed by the player may be transferred in addition to the sacrifice contents. The transfer of the point in a game is basically similar to the transfer of the sacrifice contents. That is, a predetermined amount of the point in a game that is an object to be transferred is decreased from the player information of the player who has lost the battle, and the decreased point in a game or a part of the decreased point in a game is added to the player information of the player who has won the battle and stored. When the player loses a battle, the point in a game is decreased. Therefore, the players are encouraged to make an effort to win a battle, and the battle game can become active.

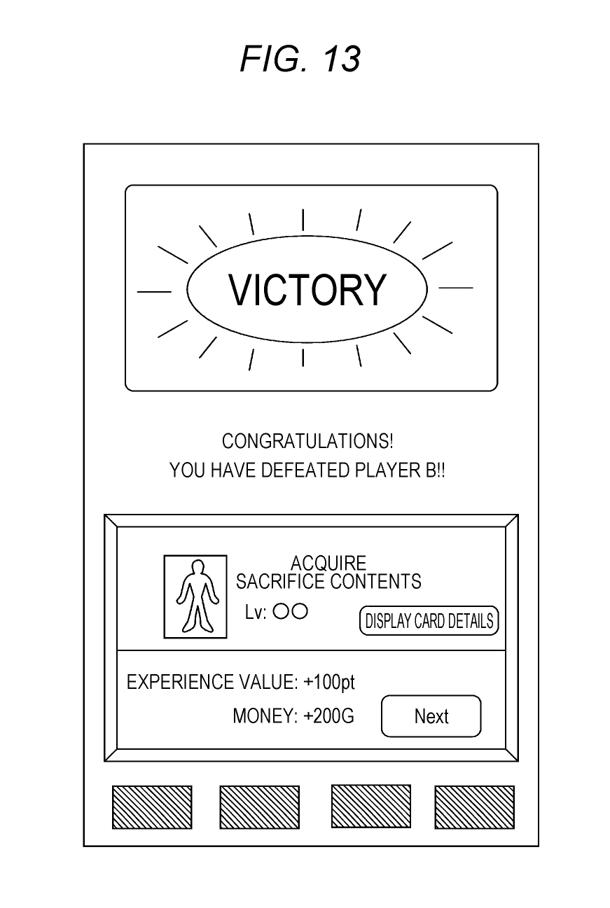

After the information change processing, the screen generation unit 115 generates data of a battle result notification screen that notifies a result of the battle (S109). The screen data is transmitted to the player terminal 20 of the player A through the communication unit 15, and is displayed in the terminal display unit 24 (S110). FIG. 13 is an example of the battle result notification screen of when the player wins a battle. On the battle result notification screen, an outcome of a battle, transfer results of the sacrifice contents and the point in a game based on the outcome are displayed. This enables the player A to confirm whether having taken the sacrifice contents of the battle opponent, or whether having been taken the own sacrifice contents by the battle opponent.

Note that data of a defeat result notification screen (not illustrated) that notifies the sacrifice contents or the point in a game has been taken due to a defeat of a battle is transmitted to the player terminal 20 of the player (the player B in the above-described example) who has lost the battle. It may be desirable that the defeat result notification screen can be confirmed by the player B immediately after the player B logs in. Further, the defeat result may be notified by means of an e-mail or the like.

Further, battle restriction processing that restricts subsequent battles is performed (S111). If the battles are repeated without any restriction, a load of the server device is increased, and the service related to the game system 1 may not be smoothly provided. Further, if allowing a battle like scramble for the sacrifice contents, a trouble and the like may occur between the players. Therefore, when battles are continuously performed in the game system 1, a certain restriction is provided. For example, an item or an energy value that is consumed when a battle is launched to another player is provided, and the battle can be performed by the number of possession of the items or the energy values, or once a battle is performed, a battle cannot be launched to another player during subsequent ten minutes. Such a condition is set as the restriction information in advance, and the battle restriction processing is performed based on the restriction information after a battle is performed, so that the battles without any restriction are suppressed.

In a battle game provided in such a game system 1, the player can advantageously develop a battle against another player by setting a strong game card as the sacrifice contents of the attack deck or the defense deck. However, when having lost a battle, the sacrifice contents are taken. Therefore, the player considers which sacrifice contents having which strength to be set to the own deck, and which player who sets which sacrifice contents to be selected as the battle opponent. This expands strategies regarding setting of the sacrifice contents, selection of the battle opponent, and the like, and can provide an interesting game without decreasing the motivation of the player for a battle.

<Modification>

A plurality of sacrifice contents may be registered to the attack deck and the defense deck. For example, when sacrifice contents set to a deck is taken by a battle opponent due to a defeat of a battle, for example, it is necessary to set new sacrifice contents again. However, the burden of the player is large if the player sets the sacrifice contents every time losing a battle. Therefore, a plurality of sacrifice contents is registered, and when the sacrifice contents are taken in a battle, predetermined sacrifice contents from among the plurality of registered sacrifice contents are automatically set.

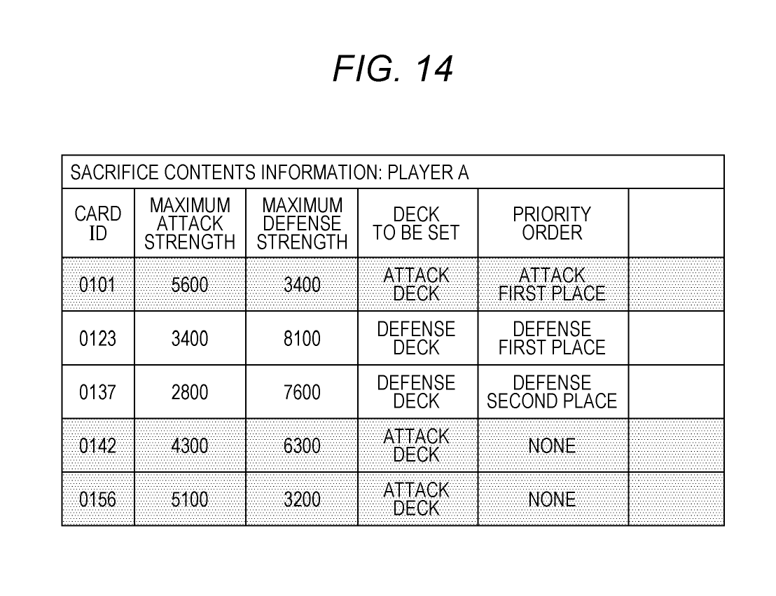

FIG. 14 is a diagram illustrating an example of a data structure of the sacrifice contents information when a plurality of sacrifice contents is set. In the sacrifice contents information of the modification, information of priority order is set regarding a plurality of game cards set as the sacrifice contents in addition to a card ID, various parameters, a deck to be set, and data related to an impact on a battle. The priority order indicates in which order the sacrifice contents are used when a plurality of sacrifice contents is registered. For example, a game card of a card ID 0123 is registered to the first place in the priority order of the sacrifice contents of the defense deck, and a game card of a card ID 0137 is registered to the second place in the priority order of the sacrifice contents of the defense deck. When being challenged to perform a battle by another player, first the battle is performed using the defense deck to which the game card of the card ID 0123 registered to the first place in the priority order is set as the sacrifice contents. When having lost the battle, the sacrifice contents (the game card of the card ID 0123) is taken. Therefore, the defense deck becomes in a state in which no sacrifice contents are set. Therefore, the control unit 11 newly sets a game card of a card ID 0137 registered to a priority order second place as the sacrifice contents of the defense deck. This can save a time and effort of the player to newly set the sacrifice contents.

The priority order may not be necessarily registered. When the priority order is not registered, the control unit 11 selects an arbitrary game card from among the plurality of game cards and sets the game card as the sacrifice contents. For example, in FIG. 14, priority orders are not registered to game cards of a card ID 0142 and a card ID 0156. In this case, one of the two game cards is selected and is set as the sacrifice contents.

### Other Embodiments

The above-described embodiments have been given for easy understanding of the present invention, and are not used to construe the present invention in a limited manner. The present invention may be altered or improved without departing from the gist of the invention, and it is apparent that the invention includes equivalents thereof. Further, embodiments to be described below are also included in the present invention.

<Battle Game Contents>

In the above-described embodiment, the battle game contents (attack deck, defense deck) are constituted by a predetermined number of game cards (in the above-described example, ten game cards) from among the plurality of game cards possessed by the player. However, a rank order may be provided in the game cards that constitute the battle game contents. For example, a configuration in which a leader game card is set in each deck, and the strength of each deck varies according to a parameter of the leader game card, or a configuration in which an outcome of a battle is determined based on a hit point parameter set to the leader game card may be employed.

<Sacrifice Contents>

In the above-described embodiment, the sacrifice contents are set separately from the game cards that constitute the battle game contents. However, one or a plurality of the plurality of game cards that constitutes the battle game contents may be set as the sacrifice contents. In this case, the sacrifice contents itself determines a battle parameter of the battle game contents (the attack deck or the defense deck), and have a function to vary the battle parameter to provide an impact on the battle.

Further, the game contents set as the sacrifice contents may be game contents that can be set as the sacrifice contents only, which is different from normal game contents (that is, a game card). For example, a sacrifice card that is different from a normal game card is provided, for example. The battle game contents (the attack deck or the defense deck) cannot be composed using the sacrifice card, and the normal game card cannot be set as the sacrifice contents. This increases a change to take a sacrifice card back from another player who has taken the sacrifice card, and the battle game can become further active.

Further, the game contents set as the sacrifice contents may be a type of an item instead of a game card.

Further, a plurality of sacrifice contents may be set to one battle. Accordingly, while, as more sacrifice contents are set, the battle parameter can be increased, all of the game contents set as the sacrifice contents are taken in a case of a defeat of a battle. Therefore, an interesting game can be provided. Note that it is apparent that a value of the battle parameter can be changed according to a combination of the plurality of sacrifice contents.

<Information Processing Apparatus>

In the above-described embodiments, the game system 1 provided with one server device 10 as an example of an information processing device has been exemplarily described. However, the game system 1 is not limited to this example, and may be provided with a plurality of server devices 10 as the information processing device. That is, a plurality of server devices 10 is connected through a network 2, and each of the server devices 10 may perform various types of processing in a distributed manner.

Further, it may be configured such that the player terminal 20 bares a part of the functions as the information processing device. In this case, the server device 10 and the player terminal 20 constitute the information processing device.

<Game Program>

In the game system 1 in the above embodiment, an example has been described, in which the server device 10 and the player terminal 20 are incorporation with each other and indirectly intervene the game progress by setting a special area at a predetermined position on the game field. However, the present invention includes a game program for executing such processing. That is, the server device 10 and the player terminal 20 as information processing apparatuses may execute the above-described each processing based on the game program.

What is claimed is:

1. A server device configured to be connected with an information processing terminal through a network, and to control a game in which a player battles against another player from the information processing terminal through the network, comprising:
a player information storage unit configured to store game contents possessed by the player, battle game contents including one piece or a plurality of game contents to be used when the player performs a battle against another player, and a battle parameter of the battle game contents;
a sacrifice contents information storage unit configured to store sacrifice contents serving as a sacrifice when the player has lost the battle against the another player, and an impact given by the sacrifice contents on the battle;
a battle processing unit configured to perform the battle of the player and the another player based on the battle parameter of the battle game contents and the impact;
a transmission unit configured to transmit information related to a result of the battle to the information processing terminal of the player that has performed the battle; and
an information change unit configured to cause, as a result of the battle, sacrifice contents of a player who has lost the battle to be not possessed by the player and to be possessed by a player who has won the battle, and to change and store information stored in the player information storage unit.

2. The server device according to claim 1, wherein
the player information storage unit stores the battle game contents based on a request from the information processing terminal of the player when the battle is performed,
the sacrifice contents information storage unit stores the sacrifice contents based on a request from the information processing terminal of the player when the battle is performed, and
the transmission unit transmits, to the information processing terminal, all or a part of information of the battle game contents and the sacrifice contents stored when the battle is performed so that a part of the information is displayed on the information processing terminal of the player before the battle is started.

3. The server device according to claim 1, wherein
the impact varies one of or both of the battle parameter of the battle game contents of the player and a battle parameter of battle game contents of the another player who battles against the player.

4. The server device according to claim 1, wherein
the sacrifice contents information storage unit stores a plurality of the sacrifice contents based on a request from the information processing terminal of the player.

5. The server device according to claim 1, wherein
the player information storage unit stores a point in a game possessed by the player, and
the information change unit decreases the point in a game possessed by the player when the player has lost the battle.

6. The server device according to claim 1, wherein
the battle processing unit sets restriction information that restricts performing of a battle next to the battle based on a predetermined condition after the player has performed the battle, and
the player information storage unit stores the set restriction information.

7. The server device according to claim 1, wherein
the battle processing unit performs a comparison of at least one of the battle parameters of the battle game contents and the impacts between the player and the another player who battles against the player, and
when a result of the comparison satisfies a predetermined condition, the battle processing unit causes a battle result to be different from a normal battle result.

8. A non-transitory computer-readable storage medium storing game program for causing a server device to realize a game in which a player battles against another player from an information processing terminal through a network, the program for causing the server device to realize:
a function to store game contents possessed by the player, battle game contents including one piece or a plurality of game contents to be used when the player performs a battle against another player, and a battle parameter of the battle game contents in a player information storage unit;
a function to store sacrifice contents serving as a sacrifice when the player has lost the battle against the another player, and an impact given by the sacrifice contents on the battle in a sacrifice contents information storage unit;
a function to perform the battle of the player and the another player based on the battle parameter of the battle game contents and the impact, by a battle processing unit;
a function to transmit information related to a result of the battle to the information processing terminal of the player that has performed the battle, by a transmission unit; and
a function to cause as a result of the battle, sacrifice contents of a player who has lost the battle to be not possessed by the player and to be possessed by a player who has won the battle, and to change and store information stored in the player information storage unit, by an information change unit.
